(19) United States
(12) Patent Application Publication
(10) Pub. No.: US 2009/0052177 A1
(43) Pub. Date: Feb. 26, 2009

(54) Light Emitting Diode Base with Radiating Fins

(75) Inventors: Shih-Wei Lin, Taipei City (TW); Chi-Chang Lin, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: AMA Precision Inc., Taipei City (TW)

(21) Appl. No.: 12/191,015

(22) Filed: Aug. 13, 2008

(30) Foreign Application Priority Data
Aug. 24, 2007 (TW) 96131536

(51) Int. Cl. F21V 29/00; F21V 21/00

(52) U.S. Cl. 362/249; 362/373

(57) ABSTRACT

A light emitting diode (LED) base with radiating fins is disclosed. The LED base includes a base plate which having a riveting structure on its bottom side, a conducting circuit, an LED unit, and radiating fins which are directly riveted to stand at the riveting structure on the bottom side of the base plate. The base plate and the riveted radiating fins are directly used as the heat dissipation module of the LED base to reduce the thermal resistance of the LED base during the heat dissipation process.

### RELATED APPLICATIONS

This application claims priority to Taiwan Application Serial Number 096131536, filed Aug. 24, 2007, which is herein incorporated by reference.

### BACKGROUND OF THE INVENTION

1. Field of the Invention

The invention relates to a light emitting diode (LED) base with radiating fins and, more particularly, to an LED base whole radiating fins are riveted to the bottom side of a circuit base plate.

2. Description of the Related Art

In recent years, the application field of a light emitting diode (LED) gradually becomes broader and broader, and the usage condition of the LED has been changed to that LEDs are arranged in a distribution type of array, so that the number of LEDs which are assembled to a single component is greatly increased, and an efficient LED with a high light output efficiency are developed to enhance the luminous efficiency. The LED array and the high thermal density of LED are relatively easy to achive a high temperature when they are used.

In the conventional technology, a common LED chip is fixed on a base plate having an electrolyte layer, and the base plate can be a multilayer plate or a metal base plate. A heat dissipation module is assembled under the base plate which is provided at the bottom of the LED in a pasting or screw locking mode. The heat energy generated by the working LED can be conducted to the heat dissipation module via the LED base plate, so that a multi-interface conducting pathway is formed. However, the number of temperature falls correspondingly increases along the increment of the number of interfaces because of the heat dissipation pathway of the heat conduction. During the production process, the LED base plate and the heat dissipation module have to be manufactured, respectively. The bottom plate of the heat dissipation module is combined with the fins by soldering tin, and then they are combined to the bottom of the LED base plate in a pasting or screw locking mode, but variance factors may be generated during the assembly process, and then affect the light emitting quality and the product life of the LED.

### BRIEF SUMMARY OF THE INVENTION

The invention provides a light emitting diode (LED) base with radiating fins. The LED base includes a base plate at one side of which an LED unit and a conducting circuit are provided, a riveting structure provided at the opposite side of the base plate and having a plurality of riveting notches which are parallel arranged with equidistant spacing, and a plurality of radiating fins which are fixedly riveted in the riveting notches and vertically stand at the base plate. The riveting structure further includes a plurality of positioning notches which are interlacedly formed at middles of intervals formed between adjacent riveting notches, and the base plate may be an aluminum base plate or a copper base plate.

In this way, the invention directly uses the base plate and the riveted radiating fins as the heat dissipation module of the LED and is different from the conventional LED base plate and the conventional heat dissipation module which have to indirectly dissipate the heat via another interface or assembly operation, so that the thermal resistance from LED to air can be decreased during the heat dissipation process.

One objective of the invention is to provide an LED base with radiating fins. Since the radiating fins are riveted to and stand at the bottom side of the base plate, that is, the base plate is directly used as the heat dissipation bottom plate of the LED base, and the invention is different from the conventional LED base plate and the conventional heat dissipation module which have to indirectly dissipate the heat via another heat dissipation base, the invention can shorten the heat dissipation pathway of conducting the heat from the LED unit to the air to reduce the thermal resistance of the thermal conducting path.

One objective of the invention is to provide an LED base whose radiating fins are directly riveted to a heat dissipation bottom plate, and the quantity of production material and the weight of the LED base can be reduced for the radiating fins are directly riveted on the base plate. The combination mode of the radiating fins and the base plate is a rivet combination mode which is a mechanism mode and improves the conventional mode of connecting the fins of a heat sink bottom plate by soldering, and then additional combination material (such as soldering tin) is not needed.

One objective of the invention is to provide an LED base with radiating fins, whose structure is simple, and since the radiating fins are riveted to and stand at the bottom side of the base plate, that is, the base plate is directly used as the heat dissipation bottom plate of the LED base, the invention can improve the conventional technology that the LED aluminum base plate and the heat dissipation module have to be combined in a soldering, pasting or screw locking mode, which decreases assembling processes during the production process, and reduce the production cost.

### BRIEF DESCRIPTION OF THE SEVERAL VIEWS OF THE DRAWINGS

These and other features, aspects, and advantages of the present invention will become better understood with regard to the following description, appended claims, and accompanying drawings.

FIG. 1A and FIG. 1B are structural schematic diagrams showing a light emitting diode (LED) base with radiating fins according to an embodiment of the invention.

FIG. 2 is a schematic diagram showing a riveting structure of an LED base according to an embodiment of the invention.

FIG. 3 is a schematic diagram showing a riveting process of an LED base according to an embodiment of the invention.

### DETAILED DESCRIPTION OF THE EMBODIMENTS

The preferred embodiment of the present invention provides a light emitting diode (LED) base with radiating fins, and the radiating fins are directly riveted to and stand at the bottom side of the base without using a pasting or screw locking combination mode, so that manufacture material is saved and the thermal resistance of the LED aluminum base plate during the heat dissipation process is reduced. The following takes a preferred embodiment which utilizes the technology of the invention as example to illustrate the content and the technology of the invention with accompanying drawings in detail.

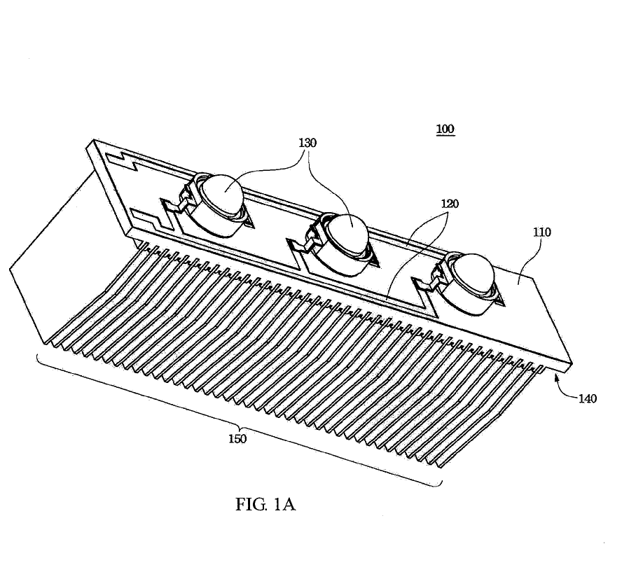

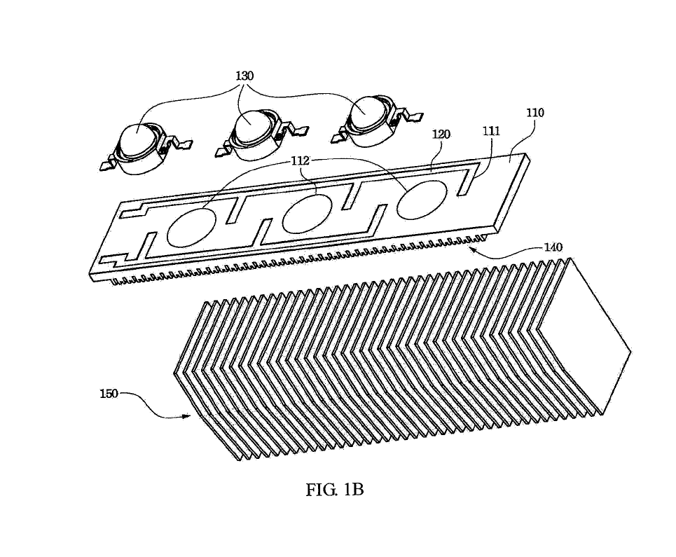

First, please refer to FIG. 1A and FIG. 1B, and FIG. 1A and FIG. 1B are structural schematic diagrams showing an LED base with radiating fins according to a preferred embodiment of the invention. As shown in FIG. 1A, the embodiment provides an LED base 100 which includes a base plate 110, a conducting circuit 120, an LED unit 130, a riveting structure 140 and radiating fins 150.

As shown in FIG. 1B, the base plate 110 is the circuit board of the LED base 100 in the embodiment and may be an aluminum base plate or a copper base plate. One side of the base plate 110 has a conducting wire trough 111 for arranging the conduction circuit 120, and the base plate 110 further has a plurality of holes 112 for installing the LED unit 130 which is connected to the conducting circuit 120 to obtain the operating electric energy.

The other side of the base plate 110 includes a riveting structure 140 for fixedly riveting a plurality of radiating fins 150 which are parallelly arranged with equidistant spacing, and the radiating fins 150 are made to vertically stand at the base plate 110.

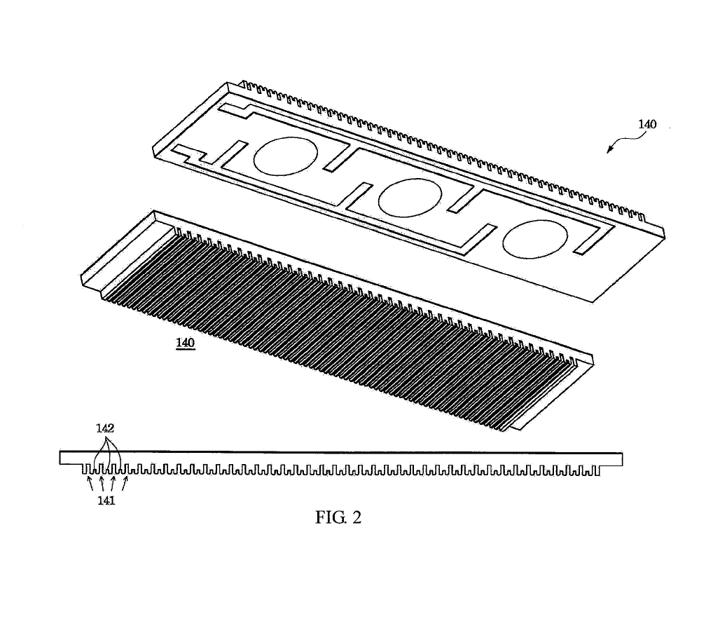

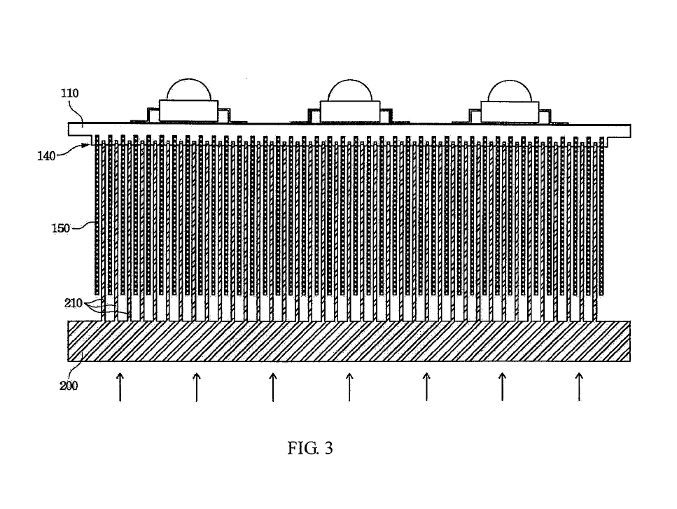

Next, please refer to FIG. 2 and FIG. 3. FIG. 2 is a schematic diagram showing a riveting structure of an LED base according to an embodiment of the invention and FIG. 3 is a schematic diagram showing a riveting process of an LED base according to an embodiment of the invention. As shown in FIG. 2, the riveting structure 140 which is provided at the other side of the base plate 110 includes a plurality of riveting notches 141 which are parallel arranged with equidistant spacing and a plurality of positioning notches 142 which are parallel and interlaced arranged in middles of intervals formed between the adjacent riveting notches 141.

The riveting notches 141 is used for inserting the radiating fins 150, and then, before the base plate 110 is riveted, the radiating fins 150 can be pre-embedded in the riveting notches 141 with a specific depth and be pre-inserted to stand at the bottom side of the base plate 110. The positioning notches 142 provide the base plate 110 with the positioning guiding notches when punches 210 (as shown in FIG. 3) of a punch press 200 punch the riveting structure 140 on the bottom side of the base plate 110 during the riveting process, and then the riveting structure 140 can bear the impact of the punches 210 which frontally faces the positioning notches 142, so that the riveting impact energy of the punches 210 can uniformly press against two side walls of the riveting notches 141, and the radiating fins 150 which are pre-embedded in the riveting notches 141 can be fixedly riveted to the base plate 110 tightly.

In this way, the LED base with radiating fins of the embodiment is formed and dose not use a conventional pasting or screw locking combination mode to fix the base plate and the heat dissipation module, so that the objective of reducing the material and the weight, saving the production cost and decreasing the assembling processes during the production can be achieved. The LED base with radiating fins of the invention can directly dissipate the heat gathered on the LED base via the radiating fins which are inserted to and stand at the bottom side, so that compared with the conventional LED base plate and the conventional heat dissipation module which have to indirectly dissipate the heat via another heat dissipation base, the invention further decreases the thermal resistance of the LED base during the heat dissipation process.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A light emitting diode (LED) base comprising:
a base plate, wherein an LED unit and a conducting circuit is provided at one side of the base plate;
a riveting structure located at the other side of the base plate and having a plurality of riveting notches which are parallelly arranged with equidistant spacing; and
a plurality of radiating fins which are fixedly riveted in the riveting notches, respectively, and vertically stand at the base plate.

2. The LED base according to claim 1, wherein the riveting structure further comprises a plurality of positioning notches which are interlacedly formed at middles of intervals formed between the adjacent riveting notches.

3. The LED base according to claim 1, wherein the base plate is an aluminum base plate.

4. The LED base according to claim 1, wherein the base plate is a copper base plate.

5. An LED module with radiating fins, the LED module comprising:
a base plate, wherein a conducting wire trough and a hole is provided at one side of the base plate;
a conducting circuit provided in the conducting wire trough of the base plate;
an LED unit provided in the hole of the base plate and connected to the conducting circuit;
a riveting structure located at the other side of the base plate and having a plurality of riveting notches which are parallelly arranged with equidistant spacing; and
a plurality of radiating fins which are fixedly riveted in the riveting notches, respectively, and vertically stand at the base plate.

6. The LED module according to claim 5, wherein the riveting structure further comprises a plurality of positioning notches which are interlacedly formed at middles of intervals formed between the adjacent riveting notches.

7. The LED module according to claim 5, wherein the base plate is an aluminum base plate.

8. The LED module according to claim 5, wherein the base plate is a copper base plate.
